(19) United States
(12) Patent Application Publication
(10) Pub. No.: US 2010/0235244 A1
(43) Pub. Date: Sep. 16, 2010

(54) METHOD AND DEVICE FOR MATCHING PEOPLE BASED ON PREPROGRAMMED PREFERENCES

(76) Inventor: Peter Clausen, Lidingo (SE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/305,829

(22) PCT Filed: Sep. 15, 2006
(86) PCT No.: PCT/SE06/01054

§ 371 Date: Dec. 19, 2008

(30) Foreign Application Priority Data
Jun. 21, 2006 (SE) 0601362-7

(51) Int. Cl. G06F 15/16; G06Q 30/00; G08B 21/00

(52) U.S. Cl. 705/14.73; 709/202; 340/540; 709/203; 709/227

(57) ABSTRACT

A method for processing client information by a first client, the client information having a plurality of client data values for matching a first and a second client, the method providing a client matching application comprising: providing a request to a second client to transmit client information to a first client if not already transmitted, step 410; determining, by the first client, a client operation, based on the client information containing client data including predetermined parameters for client matching, that is compatible with the client devices step 420; and performing one or more client based processing operations including synchronization and transmission of client information based to provide the matching application of a first and a second client within a predetermined distance of the clients. The invention also relates to a device, a computer program product, and a system.

### TECHNICAL FIELD

The present invention relates to a method, client device, computer program product and system for processing client information, in particular for matching clients.

### BACKGROUND

Today, there is an ever increasing demand for establishing contacts between individuals. Because of that demand there have been many different ways developed to do this, for instance meeting points are provided, where people can meet each other. Of course, today there are also virtual meeting points, such as Internet based sites, for instance chatting sites. Such sites are suitable for creating new contacts, but normally suffer from drawbacks such as targeting or proper matching, of which the latter expression in this disclosure will be used to include establishing, creating and targeting a desired contact. For instance, it might be hard to ensure that a desirable contact has been established and there are often problems as regards anonymity etc. Typically, prior art solutions provide an indirect way to match contacts and are often insecure, such that telephone numbers etc have to be given to be able to establish a new contact before at least some security exists. Moreover, it is often hard to match a contact according to any parameters, but the matching is normally provided almost without any selection. Thus, it is hard, or impossible to focus on the right contact without having established a high number of contacts before in an insecure way.

Similar situations also occur for targeting advertisements, in particular matched according to a particular client's interests or needs. Moreover, some Internet online service providers have derived revenue by providing so-called chatting services combined with advertisements to users. For example, when a user accesses a site (a web page) on the Internet, an advertisement (often referred to as a so-called banner) may be displayed to the user as part of the web page. Typically, also in such systems, each user accessing a certain site is shown the same advertisement though they have different preferences. Some more sophisticated systems have the capability to change the advertisement after a certain period of time, but still require improvements to better target finding relevant potential clients. Similar services are provided to users of handheld devices such as broadcasting TV-programs to cellular phones, c. f. recently introduced DVB-H based broadcasting multimedia to handheld devices, whereby TV-programs and commercials are broadcasted to users of cellular phones. Also chatting features have recently been introduced also in handheld devices such as cellular phones. However, also these services suffer from similar targeting problems as described in relation to the conventional Internet services.

While many matching services can be found on the Internet, they are limited in terms of spontaneity, geographic relevance, and cannot address needs which come from a particular situation. For example, a night club might want to invite by-passers with free entry, a single person sitting in a café might be interested in making contact for a potential relationship with any other person sharing his or her interests but not anybody, or someone might want to sell his or her mobile and an interested buyer passes be next to him or her without knowing about the opportunity for a deal.

Thus, according to our best knowledge, none of the existing techniques present a way suitable for establishing new contacts in a more direct, targeted way, or providing solutions to the situation described in the previous paragraph, i. e. matching contacts with each other, although already existing infrastructure could possibly support such techniques.

### SUMMARY OF THE INVENTION

An aspect of the present invention is to provide a new method, device, computer program product, and system for processing client information, to solve the problems set forth above.

According to a first aspect of the present invention, this is achieved by a method for processing client information containing client data by a first client. The method comprises the steps of:

providing a request to a second client to transmit client information to the first client if not already transmitted;

determining, by the first client, a client operation, based on the client information containing client data including predetermined parameters for client matching, that is compatible with the clients; and

performing one or more client based processing operations including synchronization and transmission of client information based on the client data to provide the matching application of said first and second clients within a predetermined distance of the clients.

According to a second aspect of the present invention, this is achieved by a client device for processing client information, the client information containing client data. The client device comprises:

first means for transmission of signals comprising client information to or from a second client device,

second means for transmission of said signals comprising processed client information to a presentation unit,

a control system arranged to process the client information so as to:

provide a request to a second client device to transmit client information to a first client device if not already transmitted;

determine, by the first client device, a client operation, based on the client information containing client data including predetermined parameters for client matching, that is compatible with the client devices; and

perform one or more client based processing operations including synchronization and transmission of client information to provide the matching application of said first and second client devices within a predetermined distance of the client devices.

According to a third aspect of the present invention, this is achieved by a computer program product for processing client information, the client information containing client data. The computer program product comprises computer-readable code portions, comprising:

an executable portion capable of providing a client application by a first client comprising the steps of:

providing a request to a second client to transmit client information to a first client if not already transmitted;

determining, by the first client, a client operation, based on the client information containing client data including predetermined parameters for client matching, that is compatible with the client devices; and

performing one or more client based processing operations including synchronization and transmission of client information based on the client data values to provide the matching application of a first and a second client within a predetermined distance of the clients.

In this disclosure, the term “client” is used. Herein, “client” is defined as a method or device including or providing a client application, which may be embodied as hard-ware combined with software, in the following denoted “client device” or alternatively embodied as a computer program product that can be run on a compatible computer, which may be located in another device communicating with the client; thus for instance the client may be located in a plug-in card that communicate with another device provided with suitable hard-ware such as a processor together providing the client application. In this case the client is embodied as soft-ware that can be run on any thereto compatible computer, of which the latter may be known per se. The basic functionality of the client however remains the same irrespective of embodiment. However, further features known per se, including cameras or other devices present in the client could also be influenced without departing from the invention.

The term “synchronization” is referred to as including that communication between a first and second client is duplex such that both clients perform the same procedure simultaneously. This is however no limitation, but only an embodiment.

One of the most important advantages with the present invention is that it provides a secure matching, i. e. it is not possible for the second client to know the real identity of the first client and vice versa. Herein, the term “secure” is mainly intended to mean that no real traceable identification means such as a telephone number or the like is given away. Secure does not necessary mean that communication is secure in computer terms such as encrypted messages etc. But, of course, existing encryption techniques or the like could be implemented. This is however, not part of the invention. Instead, the term “secure” mainly means that the clients each have their unique identification code, which is used instead of a “real” identification such as a telephone number, e-mail address or the like.

Another advantage with the present invention is that matching is made against predetermined parameters within a predetermined limited range. This range could be almost any suitable for short distance wireless communication, say from 10-50 meters in distance.

Yet another advantage is that communication between clients is typically not dependent on a service provider such as an operator providing a mobile communications network. However, this feature may or may not be present depending on desire.

The second client could be in the form of a master client device such as a server, which typically has a plurality of thereto connectable or communicating further client devices (and perhaps also other clients).

In this way, for instance targeted information distributions systems such could be provided. This is described in more detail as follows.

According to another aspect of the present invention, there is provided a computer program product for performing the method.

It is appreciated that the computer program product is adapted to perform all embodiments relating to the above described method, as is apparent from the attached set of dependent system claims.

The present invention also relates to a system for processing client information. This system comprises a plurality of client devices according to the present invention.

Additional features and advantages of the present invention are disclosed by the appended dependent claims.

### BRIEF DESCRIPTION OF THE DRAWINGS

To further explain the invention embodiments chosen as examples will now be described in greater details with reference to the drawings of which:

FIG. 1 is an illustration of a system for processing client information according to an embodiment of the present invention. The system includes multiple client devices communicating within the system.

FIG. 2 is an illustration in more detail of a client device of the same system as illustrated in FIG. 1.

FIG. 3 illustrates an example of settings (corresponding to parameters) as they appear to a client and a possible algorithm for illustrative purposes.

FIG. 4 is an illustration of a block schematic of the client device, illustrated in FIGS. 2 and 3 according to an embodiment of the present invention.

FIG. 5 is an illustration of a flow chart of a method for processing client information according to an embodiment of the present invention.

### DETAILED DESCRIPTION OF THE INVENTION

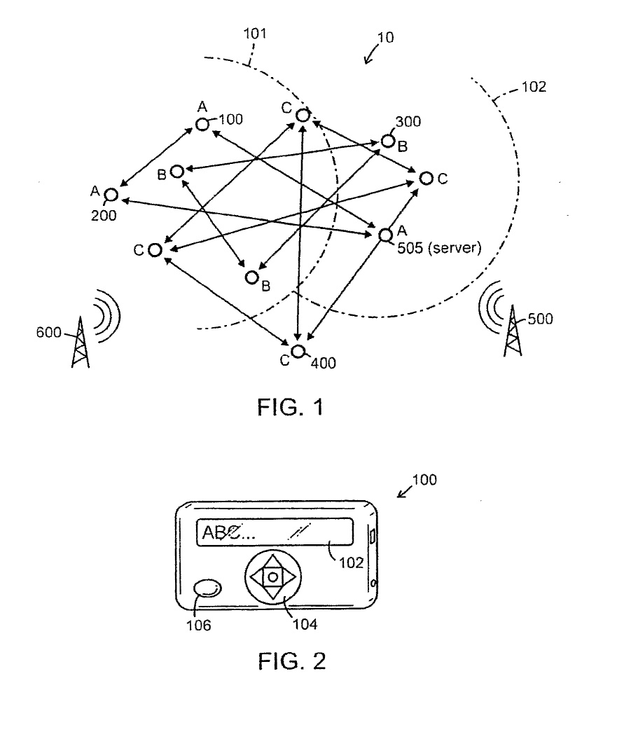

Referring now to FIG. 1, there is illustrated a system 10 for processing client information according to an embodiment of the present invention. The system 10 illustrated in FIG. 1 includes twelve clients, of which a first client 100, a second client 200, a third client 300, and a fourth client 400 are indicated by reference numerals. The clients 100, 200, 300, 400 are provided with contact parameters A, B, C. These contact parameters intend to illustrate that one client device with contact parameters A could be synchronized with another client device provided with corresponding matching parameters A. Optionally, which is illustrated in FIG. 1, one or more of the clients 500 and 600, in this case two, could be embodied as a cellular base station. The clients 100, 200, 300, 400, communicate wirelessly with each other by means of radio communication, which is schematically indicated by double-headed arrows. The number of clients 100, 200, 300, 400 is by no means limited to a particular number, but could be almost any, for instance 50. Each client 100, 200, 300, 400 has a limited operational coverage area, for instance ranging 50 m maximum in diameter, but of course some clients, typically the cellular base stations 500, 600 may have a much larger coverage area. This is schematically indicated by means of circles for the smaller areas 101, 201, 301 indication radio coverage area and radio propagation waves (no reference numeral) irradiating from the base stations 500, and 600. The wireless communication between the clients 100, 200, 300, 400 could be provided by means of peer-to-peer radio communication in a way known per se, typically by means of a technique suitable for short distance communication, i. e. the radio transmitters have limited transmission power. This is normally favorable because client information is then only distributed within a limited area. Frequency ranges could be selected from so-called free frequencies, i. e. frequencies that do not require permission from authorities, but of course also other frequencies, which are not free, may be used, even though they are typically not preferred. Examples of ranges for free frequencies are: 868-870 MHz and 902-928 MHz. Typically, the ranges differ from country to country, or regionally. Thus, the frequencies may be other than the examples given. One client may also be embodied as a “master” client, in the form of a web server, or the like, provided with radio circuitry for wireless short-distance communication. Such a client could be provided within a store for instance for providing other visiting clients with information such as advertisements etc, for instance transmitted by SMS (locally or regionally). This will be described in more detail in the following.

The communication lines between the master clients 500, and 600 and data bases, or other sources of information (not shown) could be any suitable such as cable connections combined with wireless applications, for instance wireless gateway/switches and a TCP/IP based network. This will not be further described herein, since it is not part of the present invention, but known per se. The master clients 500, 600 could be further provided with circuitry and computer programs to provide programming or updating of the clients 100, 200, 300, 400, also automatically, i. e. without operator assistance, provided the client operator has accepted this. Typically, there will be a message that new software could be downloaded.

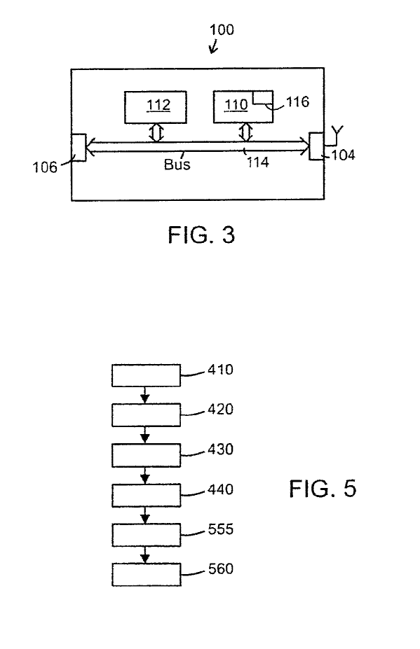

Referring now to FIG. 2, there is illustrated an embodiment of the present invention in the form of a physical client device 100, schematically illustrated. The client device 100 comprises a presentation unit 102, herein in the form of a display for numeric or alpha-numeric output, an input device such as a navigator 104, herein a conventional joy-stick device for handheld devices, and an indicator 106 for, to a client, indicating matching visually or tactile, herein embodied as a light-indicating device. An optional built-in indicator such as a buzzer (not illustrated) could be provided instead or in combination to the light-indicating device 106. Not visible, but contained therein, the client device 100 further comprises conventional radio circuitry and antenna (or other means for communication such as circuitry for Bluetooth, infrared IR) or the like) for receiving/transmitting radio waves for transmission of client data, a storage such as a memory, and a power supply such as a battery (not shown). Typically, as already mentioned briefly, the radio circuitry is configured to provide at least limited operational range, typically 10-50 m in distance (effective to another client device) similar to a communication radio device such as a walky-talky, and operates according to predetermined parameters. In this way, a mobile communications network controlled by an operator does not have to be used, which typically is very cost-effective and convenient for a client. Thus, typically the client device is independent of cellular network infrastructure and particular service providers such as operators for cellular networks. Moreover, it operates over the entire world without any restrictions due to network infrastructure such that different cellular standards such as GSM or AMPS do not have to be compatible. In this way, many different clients over the entire world could easily benefit from the invention. Typically, the client devices request all other client devices within a specific limited coverage area. All other devices notice that passively, but only matching devices establish a link for exchange of client information. This is unique with the present invention.

According to an alternative embodiment, there is also provided a “time-out” feature such that messages from one client to another will only be received once during a predetermined period of time say 30 minutes.

The client device 100 is also provided with a unique client identification code (not illustrated in this figure) configured to provide secure communication between a plurality of clients. The purpose of the client identification code built-in is to establish contact between two or more clients when desired according to operator settings, provided these clients are within range to each other, i. e. for instance radio coverage is sufficient.

Of course, alternatively, the client device 100 may be configured to operate with a particular service provider only, for instance configured to receive messages broadcasted from a particular service provider within a predetermined range, such as to receive advertisements inside a store or the like, at exhibitions, internally in a company etc. An advantage with the latter embodiment of the present invention is that in this way a larger group of clients (operators) having particular preferences could be provided with information within a predetermined geographical area. The configuration is typically operated by an operator such as a user, but of course also other criteria for configuration could be provided instead. Herein, the term “operator” is primarily referred to as user.

The client could also be used as an instrument for measuring distances between two clients, or to determine co-ordinates or provide paging features.

Each client 100, 200, 300, 400 is typically, but not necessarily, provided in the form of a physical client device, including a computer and radio circuitry. The client device is configured to communicate with another client device and able to access the server 500.

The client device may be, for example, a complete stand-alone unit having radio circuitry and being provided for the client application task only, but may also be implemented or configured to be implemented in a conventional portable communication unit such as a PDA (Personal Digital Assistant) using a conventional operating system, or may be provided as a more application specific (usually simpler) hard ware unit provided with software together providing the client application. A typical example of the latter could be a plug-in card provided with client application specific software, which card is configured to be inserted into a conventional portable communication unit such as a PDA.

According to an alternative embodiment, the client is also configured to be able to communicate with networks such as the Internet, or an intranet, for participation in conventional chatting sites etc. Also this embodiment benefit from the inventive basic principle of secrecy by means of using the unique client identification code. Thus, an operator does not have to give his/her telephone number, or any other traceable contact data such as e-mail etc, but only the unique client identification code. Of course, the unique client identification code could be turned off if desired by the operator. However, this feature will not be described in more detail.

Protocols, routines etc that are configured for a particular communication could be updated, or changed by means of downloading new such routines etc.

Thus, in an alternative embodiment of the present invention, a Palm Pilot device or similar PDA device is programmed to receive input from its serial port attached to a device according to the invention. In this embodiment, no display, keypad etc are required because these elements could be provided by the other device, i. e. the Palm Pilot device, or the PDA to which the inventive client device is connected.

The PDA device is programmed with software to co-operate with the inventive device or alternatively, the inventive device could be provided as a pure software-solution that is downloaded in the Palm Pilot device or the PDA. The device or the PDA device can be docked to a central station to transfer a log or entered data. Different types of adapters could also be provided to connect the client device to other hard ware. New software versions, manuals etc could also be downloaded in this way. Manuals could of course also be distributed in another way, for instance on a record carrier such as a CD comprising routines, configurations etc. From that point on, there are many uses for the information which can be made available online through the Internet as well.

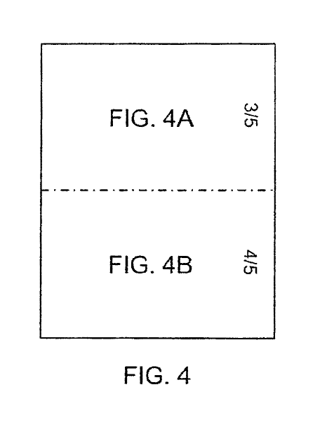

Now is referred to FIG. 3, which is an illustration of a block schematic of a client 100, according to a preferred embodiment of the present invention, in the form of a client device. The client device 100 comprises a first transmission unit 104 for transmission of data signals comprising decision parameters for matching, as well as client information to or from a second client (or the server 500). This first transmission unit 104 could be of any conventional type including input/output elements for receiving and transmitting video, audio and data signals wirelessly. Typically, the first transmission unit 104 includes conventional radio circuitry including an antenna (not shown) for radio communication. However, the present invention is by no means limited to radio communication, but also other wireless communication such as mobile telephone technology, NMT, GSM, 3-G, Bluetooth, w-lan, it etc could be employed instead. The client 100 also comprises a second transmission unit 106 for transmission of said processed signals comprising processed client information to a presentation unit, typically a display (not shown). Located between these two units 104, 106 there is provided a control system 108 arranged to process the client information.

Typically, this control system 108 comprises a processor 110 connected to a computer memory 112 with a system bus 114, in which memory 112 reside computer-executable instructions 116 for execution; the processor 110 being operative to execute the computer-executable instructions 116 to perform all method steps as will be described below. Interfaces, communication protocols etc required for receiving input from, and interacting with an operator for instance by means of the joy-stick (see FIG. 2) will not be described in more detail since this is conventional technology and therefore obvious for a person skilled in the art of electronics and computer science to design. The memory is typically configured to store routines, settings, received messages, different answering messages, which is also known per se to design for the skilled person. There could also be provided circuitry for switching communication channel, such that a general channel could be used for establishing contact, whereby another channel is used for transfer of client data. This is not illustrated in detail but within the scope of the invention.

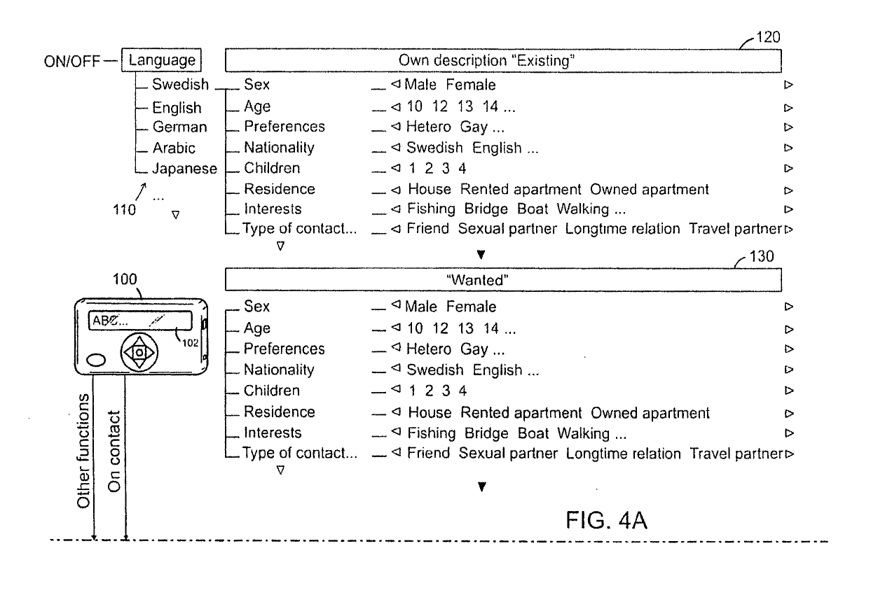

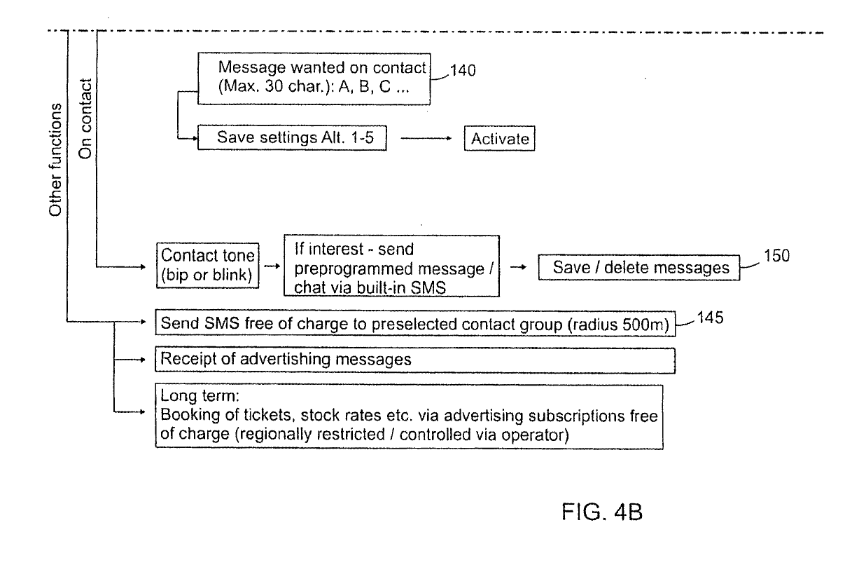

Now is referred to FIG. 4 illustrating an example of settings (corresponding to parameters) as they appear to an operator of a client device, and a possible algorithm for illustrative purposes. At the same time, it is also referred to FIG. 5, illustrating the thereto related method steps according to an embodiment of the present invention.

The device is typically operated as follows, though a number of alternatives are possible. In this figure, selections are made from a menu by means of the joy-stick for instance, but are not shown in more detail. Also selection of menus etc is known per se. Thus, only the functionality of the menus directly related to the invention will be illustrated and described.

To simplify, the menus are illustrated schematically within brackets, where each bracket represents a heading of a new menu.

The client switches the device 100 on or off by pressing a power on/off button (not shown). Thereafter a preferred language is selected [language], herein Swedish, from a first menu 110. Typically, this is only done the first time of application. Then, the selected language is stored in the store for later use.

A new menu appears 120 presenting personal information such as sex, age, nationality etc. It is important to note that the information given is only an example, not a limitation. Thus, also business related information or the like could be entered instead.

Typically, this menu 120 contains similar personal information as normally on dating sites or the like. In this menu, or in a next menu 130, as illustrated herein, desired information is entered by the operator. This information will be used for future matching purposes.

Finally, a contact message 140 for transmission to a second client in case of matching is recorded or selected. Typically, each client device 100 transmits a request according to a scheme such as a request each minute or the like. Typically, the frequency of requests depends on traffic intensity, i. e. number of units within coverage area, such that many client devices present at the same time provides fewer requests and vice versa. However, there are no limitations, but normally maximum efficiency is requested. This request typically comprises the unique client identification code (similar to serial number) of the client device. Each client device, provided it is turned on, typically searches for requests coming from other client devices.

The client device 100 could also be configured to receive other information such as SMS, advertisements etc from a second client in the form of a base station or server. The described algorithm is for illustrative purposes. Countless other algorithms can be developed to achieve the same result and an exhaustive description would not be possible. Claims for such algorithms would similarly be impossible to construct.

For example, another embodiment of the present invention would be to have a device in one of two modes: Scan Mode and Match Mode. When in Scan Mode, the device expects to read in SMS, advertisements etc only. In this mode the operator, i. e. the user of the client device, typically a customer, could decide if he/she would like to receive advertisements, and also of which type for instance in exchange to his/her unique code. In this way an advertiser could target group (segment) advertisements to interested clients (customers only). Parameters (programming) related the Scan mode could be provided directly from the client device or alternatively from the Internet by means of another conventional programming device such as a PC. For instance, if a client is about to visit a place, he/she could program his/her client device in advance such that relevant tourist guides or maps is/are received when reaching the place. This feature could also be employed for ordering for instance a taxi. A user who desires a taxi from a particular company could define his/her parameters according to this. When he/she is close enough to a taxi a beep or some other indication indicates a free taxi.

When in Match Mode, the device expects to perform client matching as will be described below in more detail. However, both modes may also exist simultaneously.

When a request has been responded to, some kind of contact message is indicated, for instance by means of the indicator 106 and possibly by the presentation unit 102, herein the display. A tone indicating matching (a beep or the like) will be provided [150].

Referring now to FIG. 5, there is shown a flow chart of a method for processing client information by a first client. The methods corresponds to what have already been disclosed above related to the client and system.

To summarize, matching is performed by the following steps:

In a first step, 410 a request to a second client to transmit client information to a first client if not already transmitted, is provided.

Then by the first client, a client processing operation, based on the client information containing client data including predetermined parameters for client matching, that is compatible with the client devices is determined, step 420.

Finally one or more client based processing operations including synchronization and transmission of client information to provide the matching application of said first and second clients within a predetermined distance of the clients is/are performed, step 430.

According to an alternative embodiment of the present invention, the step of: requesting the second client to transmit a unique client identification code identifying the second client, if and only if the predetermined parameters for client matching correspond to desired settings of parameters, step 411.

According to an alternative embodiment of the present invention, the step of: performing said one or more client based image processing operations comprises processing the received information to provide displayable information about the second client, step 440.

All of this is obvious for a person skilled in the art of electronics and/or computer science to perform and/or implement, based on the information already given in this context. Thus, this will not be described in more detail. Any suitable computer language and/or electronics could be employed fore this purpose.

An area of application for the present invention is advertising, for instance clothes or the like, whereby a customer could be presented relevant information to influence him/her buying a particular product. This is however only a non-limiting example of a typical application.

As will be further explained below, the client could alternatively be provided as a computer program product (referred to as a client application) that can be executed by a computer, for instance located in an already provided handheld communication device such as a PDA or cellular phone, and is preferably configured and provided as an independent application program or a DLL. This computer program product could be stored on a record carrier such as a USB, or be downloaded from the Internet. This is not shown in any drawing figure, since the operating principle could easily be derived from the disclosure of the client device in FIGS. 2 and 3 as explained above.

The client application may be installed during manufacture of the client device, or may be downloadable as a consequence of other processes. Furthermore, the client application may be activated either manually or automatically, and can be run from a remote location such as the web-server in a way known per se.

The client may also be, for example, another type of cordless portable, typically handheld communication device, such as a PDA, or an appropriately Internet-enabled cordless handheld device. The particular type of device (or providing the client is not considered to be important so long as the client can provide some measure of interactivity with another client and the web server.

The web server 500 may be of the type known in the prior art that has the ability to communicate with local clients by means of an intervening network such as the Internet. It should be appreciated that the web server 500 in addition to that preferably is representative of any source of client data and capable of receiving operator and user input. Thus, for example, the web server 500 could be accessible from the Internet, or it could be a part of an intranet and represents any number of web servers, some including or having access to data bases.

Interactions between the web server 500 and clients 100, 200, 300, 400 and between the clients are facilitated by a variety of software protocols (i.e., communication conventions, rules and structures), including application level protocols, for managing the transfer of data across the network and to the client applications of the clients. A protocol may be proprietary or exclusive such that only client software may be used to communicate with the server software.

The client application preferably provides the user with the opportunity to close the session, then the client application closes the communication channel to the online service, and the method ends.

In addition to manual closure, the client application preferably can automatically close the communication channel, for instance after a predetermined period of time.

Throughout this description, the embodiments shown and described should be considered as examples, rather than limitations of the invention.

It is to be understood that, when reference is made in this disclosure to the term “display” this refers generically either to a display screen on its own or to the screen and an associated housing, drive circuitry and possibly a physical supporting structure.

1. A method for processing client information by a first client, the client information comprising client data for matching a first and a second client, the method providing a client matching application comprising:
providing a request to a second client to transmit client information to a first client if not already transmitted, step 410;
determining, by the first client, a client processing operation, based on the client information containing client data including predetermined parameters for client matching, that is compatible with the client devices step 420; and
performing one or more client based processing operations including synchronization and transmission of client information to provide the matching application of said first and second clients within a predetermined distance of the clients, step 430.

2. The method of claim 1, wherein providing a request comprises:
requesting a second client in the form of a master client device such as a server, to transmit client specific information according to parameters selected by the first client 100.

3. The method according to claim 1, wherein providing a request comprises:
requesting the second client to transmit a unique client identification code identifying the second client, if and only if the predetermined parameters for client matching correspond to desired settings of parameters, step 411.

4. The method according to claim 1, wherein performing said one or more client based processing operations comprises indicating a match associated with the desired parameter settings, step 430.

5. The method according to claim 4, wherein performing said one or more client based processing operations comprises processing the received information to provide displayable information about the second client, step 440.

6. The method according to claim 4, wherein performing said one or more client based processing operations comprises processing the received information to transmit displayable information about the first client, step 441.

7. The method according to claim 1, wherein the step of determining comprises checking if a received client identification code from a second client already has been received, and if not establish a link between the first and the second client, step 421.

8. The method according to claim 1, wherein performing one or more client based processing operations comprises processing client information based on client input, step 442.

9. The method according to claim 1, wherein performing one or more client based processing operations comprises exchanging search parameters and profiles to support matching.

10. The method according to claim 1, comprising the further steps of:
displaying advertisements to a user of an online service using a client application on a client device.

11. The method according to claim 10, further comprising the steps of:
the client receiving targeted information from a local source such as company.

12. A computer program product for processing image information, the image information having a plurality of data values, wherein the computer program product comprises computer-readable client identification code portions comprising, an executable portion (116) capable of providing a client application comprising the steps of:
providing a request to a second client to transmit client information to a first client device if not already transmitted;
determining, by the first client, a client operation, based on the client information containing client data including predetermined parameters for client matching, that is compatible with the client devices; and
performing one or more client based processing operations including synchronization and transmission of client information to provide the matching application of a first and a second client within a predetermined distance of the clients.

13. A client device (100) for processing client information, the client information having a plurality of data values, comprising:
first means (104) for transmission of signals comprising client information to or from a second client,
second means (106) for transmission of said signals comprising processed client information to a display,
a control system (108) arranged to process the client information so as to:
provide a request to a second client device (200) to transmit client information to a first client device (100) if not already transmitted;
determine, by the first client device (100), a client operation, based on the client information containing client data including predetermined parameters for client matching, that is compatible with the client devices (100, 200); and
perform one or more client based processing operations including synchronization and transmission of client information to provide the matching application of said first and a second client devices (100, 200) within a predetermined distance of the clients.

14. A client device according to claim 13, wherein said control system (108) comprises a processor (110) connected to a computer memory (112) with a system bus (114), in which memory (112) reside computer-executable instructions (116) for execution; the processor (110) being operative to execute the computer-executable instructions (116) to:
provide a request to a second client device (200) to transmit client information to a first client device (100) if not already transmitted;
determine, by the first client device (100), a client operation, based on the client information containing client data including predetermined parameters for client matching, that is compatible with said client devices (100, 200); and
perform one or more client based processing operations including synchronization and transmission of client information to provide the matching application of a first and a second client device (100, 200) within a predetermined distance of the client devices (100, 200).

15. A client device according to claim 13, further comprising a plug-in card for a handheld device such as a cellular phone, PDA or the like.

16. A client device according to claim 13, comprising a presentation unit, such as a display, for presenting client information.

17. A client device according to claim 16, comprising a user input device such as key-pad or joystick.

18. A client device according to claim 16 comprising an indicator for matching, including visual or audible indicators such as a LED, and/or a buzzer.

19. A system (10) for processing client information, the client information having a plurality of data values, said system (10) comprising:
one or more client devices (100, 200, 300, 400) for processing client information, the client information having a plurality of data values, comprising:
first means (104) for transmission of data signals comprising client information to or from a second client (500),
second means (106) for transmission of said data signals comprising processed client information to a display,
a control system (108) arranged to process the client information so as to:
provide a request to a second client to transmit client information to a first client device if not already transmitted;
determine, by the first client, a client operation, based on the client information containing client data including predetermined parameters for client matching, that is compatible with the client devices; and
perform one or more client based processing operations including synchronization and transmission of client information based on the client data values to provide the matching application of a first and a second client within a predetermined distance of the clients.

20. A system (10) according to claim 19, wherein one client (200) is a web-server.
